(19) United States
(12) Patent Application Publication
(10) Pub. No.: US 2011/0103464 A1
(43) Pub. Date: May 5, 2011

(54) Methods and Apparatus for Locally Adaptive Filtering for Motion Compensation Interpolation and Reference Picture Filtering

(76) Inventors: Yunfei Zheng, Plainsboro, NJ (US); Oscar Divorra Escoda, Barcelona (ES); Peng Yin, Plainsboro, NJ (US); Joel Sole, Plainsboro, NJ (US)

(21) Appl. No.: 12/737,109

(22) PCT Filed: Jun. 5, 2009
(86) PCT No.: PCT/US2009/003431

§ 371 Date: Dec. 8, 2010

(30) Foreign Application Priority Data
Jun. 12, 2008 (US) 61/060929

(51) Int. Cl. H04N 7/26

(52) U.S. Cl. 375/240.02; 375/E07.193; 375/E07.027

(57) ABSTRACT

Methods and apparatus are provided for locally adaptive filtering for motion compensation interpolation and reference picture filtering. An apparatus includes an encoder for encoding picture data. The encoder includes at least one locally adaptive filter for performing locally adaptive filtering for at least one of reference picture filtering and interpolation filtering with respect to the picture data.

### CROSS-REFERENCE TO RELATED APPLICATIONS

This application claims the benefit of U.S. Provisional Application Ser. No. 61/060,929 (Attorney Docket No. PU080087), filed 12 Jun. 2008, which is incorporated by reference herein in its entirety.

### TECHNICAL FIELD

The present principles relate generally to video encoding and decoding and, more particularly, to methods and apparatus for locally adaptive filtering for motion compensation interpolation and reference picture filtering.

### BACKGROUND

Currently, adaptive interpolation filtering techniques are used with filters optimized to consider global data, that is, picture data from the entire picture. This means that the filter averages (or otherwise globally combines) signal statistics from all over the picture. This fact impacts the filtering power of such adaptive interpolation filters which, in many cases, leads to an over-filtering in some regions of a picture and an under-filtering in other regions of the picture.

Moreover, adaptive reference filters can be used for motion compensation. There exist scenarios in which the motion compensated prediction is not efficient and/or is problematic. For example, one such problem is the discrepancy of sharpness/blurriness between a reference frame and a current frame to be encoded (caused by, for example, changing focus, camera panning with hand-held devices, special effects created for a scene change, and/or so forth). Adaptive reference filters can reduce such discrepancies. In addition, reference filtering can be used for aliasing reduction and quantization noise suppression prior to motion compensation. However, the filters are computed to be optimal, on average, for the whole set of data used for motion compensation in a particular region.

The prior art for adaptive reference frame filtering targets generating the sub-pixel reference for motion compensation. For example, an adaptive interpolation filter has been proposed on a frame basis in a first prior art approach. After obtaining the motion vectors using an interpolated reference frame with a fixed six-tap filter in accordance with the International Organization for Standardization/International Electrotechnical Commission (ISO/IEC) Moving Picture Experts Group-4 (MPEG-4) Part 10 Advanced Video Coding (AVC) standard/International Telecommunication Union, Telecommunication Sector (ITU-T) H.264 Recommendation (hereinafter the “MPEG-4 AVC Standard”), the coefficients of the adaptive interpolation filter are calculated by minimizing a matching error measure such as sum of square difference (SSD) or sum of absolute difference (SAD). The adaptive filter is used to generate the interpolated reference picture, with the latter then being used for motion compensation. The process does not carry out further motion estimation with the newly interpolated sub-pixel reference. The filter design is constrained to be separable into vertical and horizontal directions and is cascaded with bilinear filters.

Further, a second prior art approach provides another version of adaptive interpolation filter that improves upon the version of the first prior art approach described above. First, the motion vectors are obtained with standard interpolation filters. Depending on the sub-pixel portion of the motion vector, different interpolation filters are designed for different sub-pixel positions. The employed filters are two-dimensional non-separable filters, with certain symmetric constraints to reduce the number of coefficients to be solved. A second motion estimation/compensation is performed with these new filters to generate a sub-pixel reference.

Also, a third prior art approach has proposed variations to the second prior art approach in order to reduce the impact in complexity that the computation of the interpolation and the adaptive filters require. In the third prior art approach, only one-dimensional (1D) filters are used. Vertical, horizontal and diagonal filters are considered to compute horizontal, vertical and diagonal sub-pixel references, respectively. Similar to previous cases, optimal filters are obtained based on a first set of motion vectors previously obtained.

Additionally, a fourth prior art approach has been proposed that, based on the current picture and a reference picture, adaptively calculates a set of filters aimed at compensating the discrepancy between these two pictures. The computed filters are then applied to the reference picture before the reference picture is used for prediction. These filters operate in the way that new references with filtered pixels are generated to provide a better match for predictive video coding.

Thus, it is common to all of the above prior art approaches that optimal filters are computed for a whole region which is often a frame or a slice. For each of these picture regions, filter coefficients are explicitly encoded and transmitted to the decoder. A typical setting for the transmission of these coefficients is to embed them within each slice header. What these approaches do not address is the reality that picture statistics change through space and, hence, optimal filters should also adapt through space.

### SUMMARY

These and other drawbacks and disadvantages of the prior art are addressed by the present principles, which are directed to methods and apparatus for locally adaptive filtering for motion compensation interpolation and reference picture filtering.

According to an aspect of the present principles, there is provided an apparatus. The apparatus includes an encoder for encoding picture data. The encoder includes at least one locally adaptive filter for performing locally adaptive filtering for at least one of reference picture filtering and interpolation filtering with respect to the picture data.

According to another aspect of the present principles, there is provided a method. The method includes encoding picture data using locally adaptive filtering for at least one of reference picture filtering and interpolation filtering.

According to yet another aspect of the present principles, there is provided an apparatus. The apparatus includes a decoder for decoding picture data. The decoder includes at least one locally adaptive filter for performing locally adaptive filtering for at least one of reference picture filtering and interpolation filtering with respect to the picture data.

According to still another aspect of the present principles, there is provided a method. The method includes decoding picture data using locally adaptive filtering for at least one of reference picture filtering and interpolation filtering.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 is a block diagram showing an exemplary video encoder with locally adaptive reference filtering, in accordance with an embodiment of the present principles;

FIG. 2 is a block diagram showing an exemplary video decoder with locally adaptive reference filtering, in accordance with an embodiment of the present principles;

FIG. 3 is a block diagram showing an exemplary set of picture blocks showing a training area for filter optimization, in accordance with an embodiment of the present principles;

FIG. 4 is a flow diagram showing an exemplary method for video encoding with locally adaptive filtering, in accordance with an embodiment of the present principles; and

FIG. 5 is a flow diagram showing an exemplary method for video decoding with locally adaptive filtering, in accordance with an embodiment of the present principles.

### DETAILED DESCRIPTION

The present principles are directed to methods and apparatus for locally adaptive filtering for motion compensation interpolation and reference picture filtering.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “I′, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Moreover, it is to be appreciated that while one or more embodiments of the present principles are described herein with respect to the MPEG-4 AVC standard, the present principles are not limited to solely this standard and, thus, may be utilized with respect to other video coding standards, recommendations, and extensions thereof, including extensions of the MPEG-4 AVC standard, while maintaining the spirit of the present principles.

Further, as used herein, the phrase “global” refers to one or more items (including, but not limited to, signal statistics) with respect to an entire picture, frame, or slice. In contrast, as used herein, the phrase “local” refers to one or more items (including, but not limited to, signal statistics) with respect to one or more, but less than all, image blocks in a picture, frame, or slice.

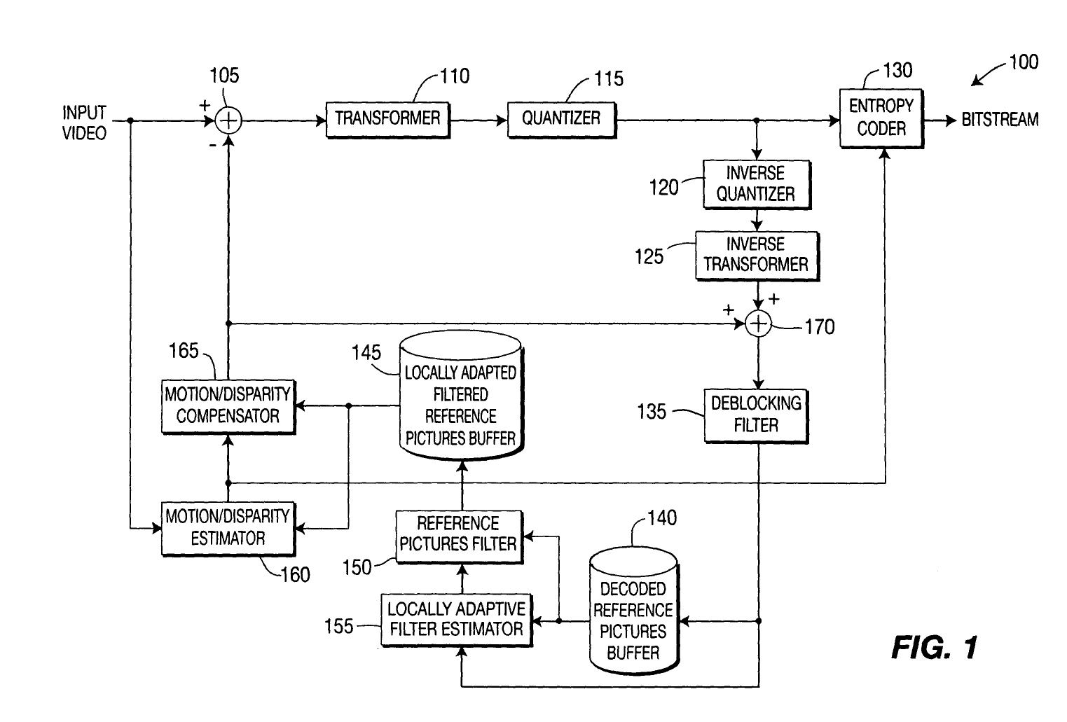

Turning to FIG. 1, an exemplary video encoder with locally adaptive reference filtering is indicated generally by the reference numeral 100. The encoder 100 includes a combiner 105 having an output connected in signal communication with an input of a transformer 110. An output of the transformer 110 is connected in signal communication with an input of a quantizer 115. An output of the quantizer 115 is connected in signal communication with a first input of an entropy coder 130 and an input of an inverse quantizer 120. An output of the inverse quantizer 120 is connected in signal communication with an input of an inverse transformer 125. An output of the inverse transformer 125 is connected in signal communication with a first non-inverting input of a combiner 170. An output of the combiner 170 is connected in signal communication with an input of a deblocking filter 135. An output of the deblocking filter 135 is connected in signal communication with an input of a decoded reference pictures buffer 140 and a first input of a locally adaptive filter estimator 155. An output of the decoded reference pictures buffer 140 is connected in signal communication with a second input of the locally adaptive filter estimator 155 and a second input of a reference picture filter 150. An output of the locally adaptive filter estimator 155 is connected in signal communication with a first input of the reference picture filter 150. An output of the reference picture filter 150 is connected in signal communication with an input of a locally adapted filtered reference pictures buffer 145. An output of the locally adapted filtered reference pictures buffer 145 is connected in signal communication with a second input of a motion/disparity estimator 160 and a second input of a motion/disparity compensator 165. An output of the motion/disparity estimator 160 is connected in signal communication with a first input of the motion/disparity compensator 165 and with a second input of the entropy coder 130. An output of the motion/disparity compensator 165 is connected in signal communication with an inverting input of the combiner 105 and with a second non-inverting input of the combiner 170.

A non-inverting input of the combiner 105 and a first input of the motion/disparity estimator 160 are available as inputs of the encoder 100, for receiving input video. An output of the entropy coder 130 is available as an output of the encoder 100, for outputting a bitstream.

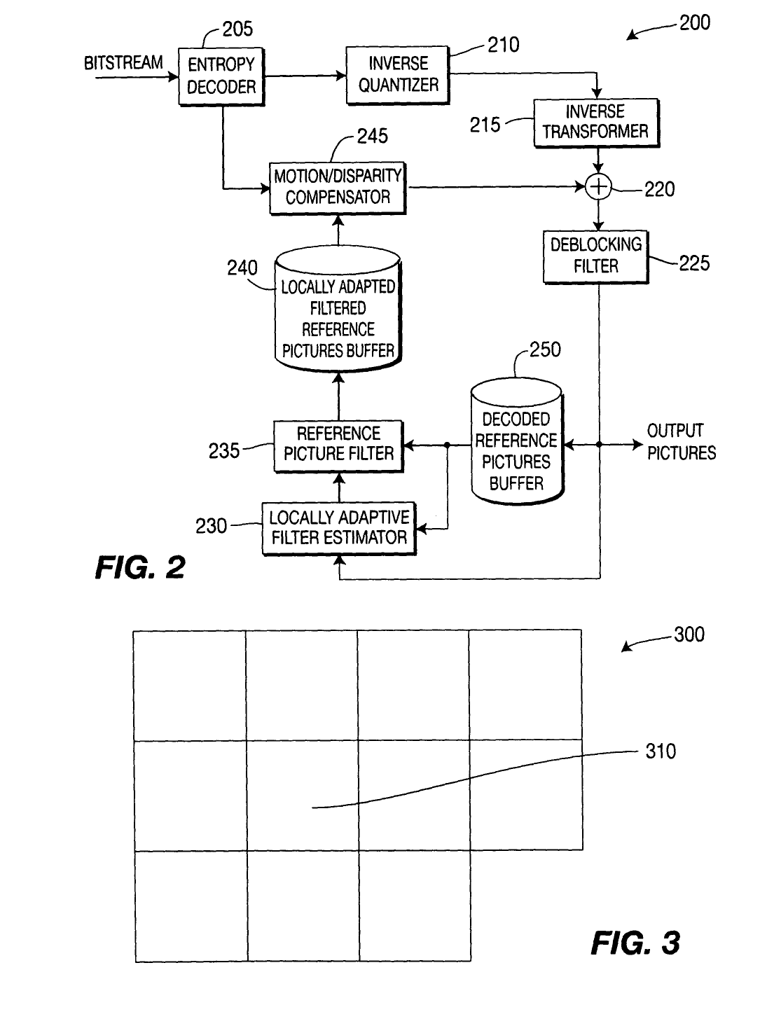

Turning to FIG. 2, an exemplary video decoder with locally adaptive reference filtering is indicated generally by the reference numeral 200. The video decoder 200 includes an entropy decoder 205 having a first output in signal communication with an input of an inverse quantizer 210. An output of the inverse quantizer 210 is connected in signal communication with an input of an inverse transformer 215. An output of the inverse transformer 215 is connected in signal communication with a first non-inverting input of a combiner 220. An output of the combiner 220 is connected in signal communication with an input of a deblocking filter 225. An output of the deblocking filter 225 is connected in signal communication with an input of a decoder reference pictures buffer 250 and a second input of a locally adaptive filter estimator 230. An output of the decoded reference pictures buffer 250 is connected in signal communication with a first input of the locally adaptive filter estimator 230 and a first input of a reference picture filter 235. An output of the locally adaptive filter estimator 230 is connected in signal communication with a second input of a reference picture filter 235. An output of the reference picture filter 235 is connected in signal communication with an input of a locally adapted filtered reference pictures buffer 240. An output of the locally adapted filtered reference pictures buffer 240 is connected in signal communication with a first input of a motion/disparity compensator 245. An output of the motion/disparity compensator 245 is connected in signal communication with a second non-inverting input of the combiner 220. A second output of the entropy decoder 205 is connected in signal communication with a second input of the motion/disparity compensator 245.

An input of the entropy decoder 205 is available as an input of the decoder 200, for receiving a bitstream. An output of the deblocking filter 225 is available as an output of the decoder 200, for outputting pictures.

As noted above, the present principles are directed to methods and apparatus for locally adaptive filtering regarding motion compensation interpolation filtering and reference picture filtering. In an embodiment, the use of locally adaptive interpolation filters (or locally adaptive reference filters) is proposed for motion compensation (MC). This is intended for local adaptation of at least an interpolation filter and/or reference filter to the picture content such that the interpolation filter and/or reference filter is trained locally on pictures in order to minimize at least aliasing and noise in the motion compensated picture in those picture regions where such a filter is selected for use.

In an embodiment we allow for the use of interpolation (and/or reference) filters that adapt to local data such that filter coefficients are optimized to local statistics of data (e.g., from a restricted set of data) rather than to the global average statistics. In another embodiment, we improve upon the concept of adaptive reference filters by proposing locally adaptive reference filters. In this way, the filters can be better adapted to the local characteristics of data for better filtering.

Thus, the present principles introduce locally adaptive interpolation filters for motion compensation. Moreover, the present principles introduce the use of locally adaptive reference frame filters.

### Adaptive Reference Filtering in Video Encoder/Decoder

In an embodiment, we introduce an additional step within the encoding and decoding process for the generation of locally adaptively filtered reference pictures.

In an embodiment, reference pictures are adaptively filtered before being used for motion compensation. In an embodiment, at least one filter is used per coded macroblock. This filter is adaptively optimized per macroblock, such that a set of neighboring pixels (from the reference frame) with respect to the current macroblock are filtered to best fit the original data. FIG. 3 shows an example of such neighboring pixels. Turning to FIG. 3, an exemplary set of picture blocks, that includes a training area for filter optimization, is indicated generally by the reference numeral 300. The filter optimization is performed with respect to the training area 310, which is also denoted by the shaded region among the blocks 300. After that, the filter that filters this neighboring data best is then used to filter any reference data to be used for predicting the current macroblock.

In an embodiment, the pixels used from the “training area” are the prediction integer position pixels from the non-filtered references before undergoing any sub-pel interpolation.

The filter operation is applied to the decoded reference pictures on the original sampling grid to generate a filtered version of the reference picture.

For the sub-pixel reference, three exemplary approaches are described herein, although given the teachings of the present principles provided herein, one of ordinary skill in this and related arts will readily contemplate these and other exemplary approaches for the sub-pixel reference, while maintaining the spirit of the present principles. The first approach involves using the generated filter for full pel reference filtering. The second approach involves generating sub-pixels with the interpolation filter of the MPEG-4 AVC Standard, but based on the pixels from the new reference picture obtained as described above. The third approach involves using adaptive filters to generate the sub-pixel reference, similar to the approach used in the second prior art approach described above.

For illustrative purposes, one or more embodiments of the present principles are described herein with respect to finite impulse response (FIR) linear filters. However, it is to be appreciated that the present principles are not limited solely to FIR filters and, thus, other types of filters may also be used in accordance with the teachings of the present principles, while maintaining the spirit of the present principles. For example, infinite impulse response (IIR) filters and nonlinear filters may also be used. Moreover, it is also possible to consider temporal methods in the design of the filter, such as three-dimensional filters that involve multiple decoded reference pictures. These and other types of filters and filtering methods may be used in accordance with the teachings of the present principles, while maintaining the spirit of the present principles.

After the adaptive filters estimation, the actual filtering operation can be applied on a local basis on-the-fly during the motion compensation process, or the whole reference picture can be filtered first and stored before being used for compensation

During the encoding process, filters are locally and adaptively designed and configured by finding a filter that minimizes a measure of distortion between the training data and the original data in order to compensate for the various mismatches per every image block. Motion compensation will be performed on a per block basis with filtered reference frames. In an embodiment, filter coefficients for each block do not need to be transmitted as the filter coefficients are backward computed at a corresponding decoder. The eventual enabling or disabling of the use of the locally adaptive filter is transmitted to the decoder for correct reconstruction. Block level filter selection may be signaled, for example, using any signaling method, including any of a variety of well-known management methods, as would be readily apparent to those of ordinary skill in this and related arts, while maintaining the spirit of the present principles. For a particular MPEG-4 AVC Standard based embodiment, the reference indexing mechanism can be used for the purpose of signaling which filter to use for the coding of a particular block. At the decoder side, locally adaptive filters will be reproduced in the same way as in the encoder. Corresponding new references generated per decoded block can then be generated to properly decode the video sequence.

In an embodiment, the adaptive filter use includes the following two steps for every macroblock: (1) filter determination/estimation; and (2) motion estimation/compensation.

### Filter Determination/Estimation

For each block, filter coefficients are calculated by minimizing a cost function for prediction errors based on a training area (see training area 310 in FIG. 3). Only pixels associated with the current filter are involved in the estimation process (e.g., the pixels in the training area). The cost function could be any non-increasing function of the absolute pixel difference such as, for example, sum of squared difference (SSD), sum of absolute difference (SAD), and/or so forth. This computed filter is then used. In order to allow the decoder to implicitly derive the filter at decoding time, available neighboring decoded data from the current encoded picture is thus used as reference for the cost function in the filter estimation process. In an embodiment, the obtained filter is the filter that best adapts the reference data for prediction in the training area of the decoded reconstructed data.

### Motion Estimation/Compensation

With the filter computed in the previous step, the reference picture is computed in order to perform motion compensation. Depending on a measure of coding cost and distortion, a given block can be encoded using or not using the locally adaptive reference filter. In an embodiment, the corresponding side information is sent to the decoder to allow the decoder to choose the operation mode.

In an embodiment, the use of sub-pel filters may be avoided when using locally adaptive reference filters. In another embodiment, the use of sub-pel filters can be adaptively selected on a macroblock basis. Moreover, in an embodiment, the use of a locally adaptive reference filter is adaptively enabled or disabled per macroblock.

TABLE 1 shows macroblock data syntax including the necessary flags for turning on/off the use of the locally adaptive reference filters at the macroblock level, in accordance with an embodiment of the present principles.

TABLE 1

| | C | Descriptor |
|---|---|---|
| macroblock_layer( ) { | | |
| mb_type | 2 | ue(v) \| ae(v) |
| if( mb_type = = I_PCM ) { | | |
| while( !byte_aligned( ) ) | | |
| pcm_alignment_zero_bit | 2 | f(1) |
| for( i = 0; i < 256; i++ ) | | |
| pcm_sample_luma[ i ] | 2 | u(v) |
| for( i = 0; i < 2 * MbWidthC * MbHeightC; i++ ) | | |
| pcm_sample_chroma[ i ] | 2 | u(v) |
| } else { | | |
| noSubMbPartSizeLessThan8×8Flag = 1 | | |
| if( mb_type != I _N×N && | | |
| MbPartPredMode( mb_type, 0 ) != Intra_16×16 && | | |
| NumMbPart( mb_type ) = = 4) { | | |
| locally_adaptive_reference_filter_flag | 2 | u(1)\|ae(v) |
| sub_mb_pred( mb_type ) | 2 | |
| for( mbPartIdx = 0; mbPartIdx < 4; mbPadIdx++ ) | | |
| if( sub_mb_type[ mbPartIdx ] != B_Direct_8×8 ) { | | |
| if( NumSubMbPart( sub_mb_type[ mbPartIdx ] ) > 1 ) | | |
| noSubMbPartSizeLessThan8×8Flag = 0 | | |
| } else if( !direct_8×8_inference_flag ) | | |
| noSubMbPartSizeLessThan8×8Flag = 0 | | |
| } else { | | |
| if( transform_8×8_mode_flag && mb_type = = I_N×N ) | | |
| transform_size_8×8_flag | 2 | u(1) \| ae(v) |
| locally_adaptive_reference_filter_flag | 2 | u(1) \| ae(v) |
| mb_pred( mb_type ) | 2 | |
| } | | |
| if( MbPartPredMode( mb_type, 0 ) != Intra_16×16 ) { | | |
| coded_block_pattern | 2 | me(v) \| ae(v) |
| if( CodedBlockPatternLuma > 0 && | | |
| transform_8×8_mode_flag && mb_type != I_N×N && | | |
| noSubMbPartSizeLessThan8×8Flag && | | |
| ( mb_type != B_Direct_16×16 \| \| direct_8×8_inference_flag ) ) | | |
| transform_size_8×8_flag | 2 | u(1) \| ae(v) |
| } | | |
| if( CodedBlockPatternLuma > 0 \| \| CodedBlockPatternChroma > 0 \| \| | | |
| MbPartPredMode( mb_type, 0 ) = = Intra_16×16) { | | |
| mb_qp_delta | 2 | se(v) \| ae(v) |
| residual( ) | 3 \| 4 | |
| } | | |
| } | | |
| } | | |

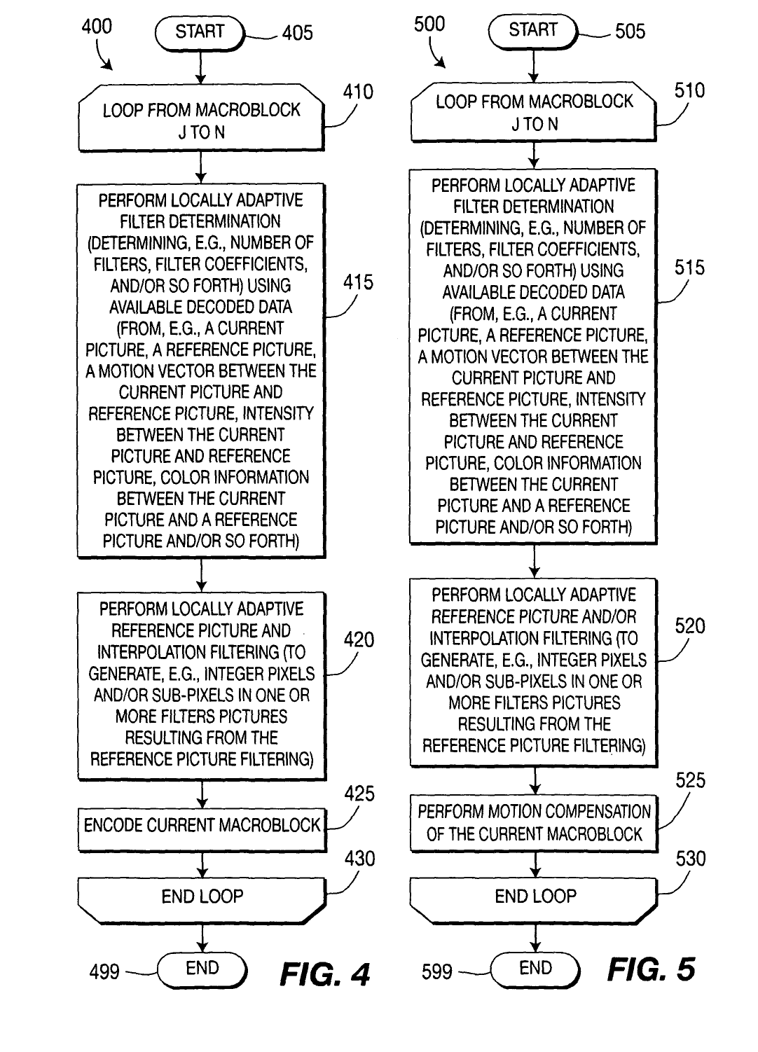

Turning to FIG. 4, an exemplary method for video encoding with locally adaptive filtering is indicated generally by the reference numeral 400. The method 400 includes a start block 405 that passes control to a loop limit block 410. The loop limit block 410 performs a loop over every macroblock from macroblock J to macroblock N, and passes control to a function block 415. The function block 415 performs a locally adaptive filter determination (determining, e.g., the number of filters to be used, the filter coefficients, and/or so forth) using available decoded data (from, e.g., at least a portion of a current picture, at least a portion of a reference picture, a motion vector between at least a portion of the current picture and at least a portion of a reference picture, intensity between at least a portion of the current picture and at least a portion of a reference picture, color information between at least a portion of the current picture and at least a portion of a reference picture and/or so forth), and passes control to a function block 420. The function block 420 performs reference picture filtering (to generate, e.g., integer pixels and/or sub-pixels in one or more filters pictures resulting from the reference picture filtering), and passes control to a function block 425. The function block 425 encodes the current macroblock, and passes control to a loop limit block 430. The loop limit block 430 ends the loop, and passes control to an end block 499.

Turning to FIG. 5, an exemplary method for video decoding with locally adaptive filtering is indicated generally by the reference numeral 500. The method 5000 includes a start block 505 that passes control to a function block 510. The loop limit block 510 performs a loop over every macroblock from macroblock J to macroblock N, and passes control to a function block 515. The function block 515 performs a locally adaptive filter determination (determining, e.g., the number of filters to be used, the filter coefficients, and/or so forth) using available decoded data (from, e.g., at least a portion of a current picture, at least a portion of a reference picture, a motion vector between at least a portion of the current picture and at least a portion of a reference picture, intensity between at least a portion of the current picture and at least a portion of a reference picture, color information between at least a portion of the current picture and at least a portion of a reference picture and/or so forth), and passes control to a function block 520. The function block 520 performs reference picture data filtering (to generate, e.g., integer pixels and/or sub-pixels in one or more filters pictures resulting from the reference picture filtering), and passes control to a function block 525. The function block 525 performs motion compensation of the current macroblock, and passes control to a loop limit block 530. The loop limit block 530 ends the loop, and passes control to an end block 599.

The semantics of the locally_adaptive_reference_filter_flag shown in TABLE 1 are as follows:
locally_adaptive_reference_filter_flag is the syntax element that indicates the use (or not) in that particular macroblock of the locally adaptive reference filter.

The use of the locally_adaptive_reference_filter_flag in the macroblock data syntax is subject to enabling adaptive use of the locally adaptive reference filter. It is to be appreciated that when the filter is set to be used permanently or is set to be never used, such a syntax element is not necessary.

A description will now be given of some of the many attendant advantages/features of the present invention, some of which have been mentioned above. For example, one advantage/feature is an apparatus having an encoder for encoding picture data. The encoder includes at least one locally adaptive filter for performing locally adaptive filtering for at least one of reference picture filtering and interpolation filtering with respect to the picture data.

Another advantage/feature is the apparatus having the encoder as described above, wherein the picture data corresponds to a current picture, and at least one of filter coefficients and a number of filters for the locally adaptive filtering are determined based on information derived from the current picture and a reference picture.

Yet another advantage/feature is the apparatus having the encoder as described above, wherein at least one of the at least one locally adaptive filter is used to generate at least one of integer pixels and sub-pixels in at least one filtered picture resulting from the locally adaptive filtering.

Still another advantage/feature is the apparatus having the encoder as described above, wherein multiple filtered reference pictures are enabled for use in encoding the picture data, and use or non-use of the locally adaptive filtering is enabled on a block basis.

Moreover, another advantage/feature is the apparatus having the encoder as described above, wherein at least one of the at least one locally adaptive filter is applied in any of one dimension, two dimensions, or three dimensions.

Further, another advantage/feature is the apparatus having the encoder as described above, wherein the picture data corresponds to a current picture, and information used to derive at least one of the at least one locally adaptive filter includes motion information between the current picture and a reference picture.

Also, another advantage/feature is the apparatus having the encoder as described above, wherein the picture data corresponds to a current picture, and information used to derive at least one of the at least one locally adaptive filter includes at least one of intensity information and color information between the current picture and a reference picture.

Additionally, another advantage/feature is the apparatus having the encoder as described above, wherein the picture data corresponds to a current picture, and filter coefficients for the locally adaptive filtering are derived based on training data.

Moreover, another advantage/feature is the apparatus having the encoder as described above, wherein the training data includes local neighboring pixels in at least one of the current picture and a reference picture.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus, comprising:
an encoder for encoding picture data, wherein said encoder includes at least one locally adaptive filter for performing locally adaptive filtering for at least one of reference picture filtering and interpolation filtering with respect to the picture data.

2. The apparatus of claim 1, wherein the picture data corresponds to a current picture, and at least one of filter coefficients and a number of filters for the locally adaptive filtering are determined based on information derived from the current picture and a reference picture.

3. The apparatus of claim 1, wherein at least one of the at least one locally adaptive filter is used to generate at least one of integer pixels and sub-pixels in at least one filtered picture resulting from the locally adaptive filtering.

4. The apparatus of claim 1, wherein multiple filtered reference pictures are enabled for use in encoding the picture data, and use or non-use of the locally adaptive filtering is enabled on a block basis.

5. The apparatus of claim 1, wherein at least one of the at least one locally adaptive filter is applied in any of one dimension, two dimensions, or three dimensions.

6. The apparatus of claim 1, wherein the picture data corresponds to a current picture, and information used to derive at least one of the at least one locally adaptive filter comprises motion information between the current picture and a reference picture.

7. The apparatus of claim 1, wherein the picture data corresponds to a current picture, and information used to derive at least one of the at least one locally adaptive filter comprises at least one of intensity information and color information between the current picture and a reference picture.

8. The apparatus of claim 1, wherein the picture data corresponds to a current picture, and filter coefficients for the locally adaptive filtering are derived based on training data.

9. The apparatus of claim 8, wherein the training data comprises local neighboring pixels in at least one of the current picture and a reference picture.

10. A method, comprising:
encoding picture data using locally adaptive filtering for at least one of reference picture filtering and interpolation filtering.

11. The method of claim 10, wherein the picture data corresponds to a current picture, and at least one of filter coefficients and a number of filters for the locally adaptive filtering are determined based on information derived from the current picture and a reference picture.

12. The method of claim 10, wherein at least one locally adaptive filter is used to generate at least one of integer pixels and sub-pixels in at least one filtered picture resulting from the locally adaptive filtering.

13. The method of claim 10, wherein multiple filtered reference pictures are enabled for use in encoding the picture data, and use or non-use of the locally adaptive filtering is enabled on a block basis.

14. The method of claim 10, wherein locally adaptive filters used for the locally adaptive filtering are applied in any of one dimension, two dimensions, or three dimensions.

15. The method of claim 10, wherein the picture data corresponds to a current picture, and information used to derive locally adaptive filters used for the locally adaptive filtering comprises motion information between the current picture and a reference picture.

16. The method of claim 10, wherein the picture data corresponds to a current picture, and information used to derive locally adaptive filters used for the locally adaptive filtering comprises at least one of intensity information and color information between the current picture and a reference picture.

17. The method of claim 10, wherein the picture data corresponds to a current picture, and filter coefficients for the locally adaptive filtering are derived based on training data.

18. The method of claim 17, wherein the training data comprises local neighboring pixels in at least one of the current picture and a reference picture.

19. An apparatus, comprising:
a decoder for decoding picture data, wherein said decoder includes at least one locally adaptive filter for performing locally adaptive filtering for at least one of reference picture filtering and interpolation filtering with respect to the picture data.

20. The apparatus of claim 19, wherein the picture data corresponds to a current picture, and at least one of filter coefficients and a number of filters for the locally adaptive filtering are determined based on information derived from the current picture and a reference picture.

21. The apparatus of claim 19, wherein at least one of the at least one locally adaptive filter is used to generate at least one of integer pixels and sub-pixels in at least one filtered picture resulting from the locally adaptive filtering.

22. The apparatus of claim 19, wherein multiple filtered reference pictures are enabled for use in decoding the picture data, and use or non-use of the locally adaptive filtering is enabled on a block basis.

23. The apparatus of claim 19, wherein at least one of the at least one locally adaptive filter is applied in any of one dimension, two dimensions, or three dimensions.

24. The apparatus of claim 19, wherein the picture data corresponds to a current picture, and information used to derive at least one of the at least one locally adaptive filter comprises motion information between the current picture and a reference picture.

25. The apparatus of claim 19, wherein the picture data corresponds to a current picture, and information used to derive at least one of the at least one locally adaptive filter comprises at least one of intensity information and color information between the current picture and a reference picture.

26. The apparatus of claim 19, wherein the picture data corresponds to a current picture, and filter coefficients for the locally adaptive filtering are derived based on training data.

27. The apparatus of claim 26, wherein the training data comprises local neighboring pixels in at least one of the current picture and a reference picture.

28. A method, comprising:
decoding picture data using locally adaptive filtering for at least one of reference picture filtering and interpolation filtering.

29. The method of claim 28, wherein the picture data corresponds to a current picture, and at least one of filter coefficients and a number of filters for the locally adaptive filtering are determined based on information derived from the current picture and a reference picture.

30. The method of claim 28, wherein at least one locally adaptive filter is used to generate at least one of integer pixels and sub-pixels in at least one filtered picture resulting from the locally adaptive filtering.

31. The method of claim 28, wherein multiple filtered reference pictures are enabled for use in decoding the picture data, and use or non-use of the locally adaptive filtering is enabled on a block basis.

32. The method of claim 28, wherein locally adaptive filters used for the locally adaptive filtering are applied in any of one dimension, two dimensions, or three dimensions.

33. The method of claim 28, wherein the picture data corresponds to a current picture, and information used to derive locally adaptive filters used for the locally adaptive filtering comprises motion information between the current picture and a reference picture.

34. The method of claim 28, wherein the picture data corresponds to a current picture, and information used to derive locally adaptive filters used for the locally adaptive filtering comprises at least one of intensity information and color information between the current picture and a reference picture.

35. The method of claim 28, wherein the picture data corresponds to a current picture, and filter coefficients for the locally adaptive filtering are derived based on training data.

36. The method of claim 35, wherein the training data comprises local neighboring pixels in at least one of the current picture and a reference picture.

37. A video signal structure for video encoding, comprising:
picture data encoded by performing locally adaptive filtering for at least one of reference picture filtering and interpolation filtering with respect to the picture data.

38. A storage media having video signal data encoded thereupon, comprising:
picture data encoded by performing locally adaptive filtering for at least one of reference picture filtering and interpolation filtering with respect to the picture data.
